(19) United States
(12) Patent Application Publication
(10) Pub. No.: US 2022/0135382 A1
(43) Pub. Date: May 5, 2022

(54) Feeding system for hydraulic jacks, hydraulic jack, kit and associated actuation method

(71) Applicant: Laura Maria BISCOTTO, Castronno (Varese) (IT)

(72) Inventor: Marino NICORA, Gallarate (Varese) (IT)

(21) Appl. No.: 17/433,996

(22) PCT Filed: Feb. 24, 2020
(86) PCT No.: PCT/IB2020/051521

§ 371 Date: Aug. 25, 2021

(30) Foreign Application Priority Data
Feb. 25, 2019 (EP) 19159072.8

(51) Int. Cl. B66F 3/42; B66F 5/04

(52) U.S. Cl. CPC B66F 3/42; B66F 5/04

(57) ABSTRACT

A feeding system for a hydraulic jack, characterized in that it comprises:
a body (101; 132) configured to contain a determined amount of fluid and having an outlet (150) through which, in use, the fluid is fed to a main hydraulic cylinder (107c) of the hydraulic jack (100);
a first pumping subsystem (121; 122; 140; 142; 123) with alternating manual drive, installed on said body (101; 132) and configured to draw the fluid from said body and feed it to said outlet (150);
a second pumping subsystem (118), distinct and independent of the first pumping subsystem, installed on said body (101; 132), configured to be rotated by a tool, and configured to draw the fluid from said body and feed it to said outlet (150).

### PRIOR ART

Hydraulic jacks are devices designed to allow the lifting of loads, and comprise a body provided with a hydraulic cylinder at least between a first position of minimum axial extension and a second position of maximum axial extension, typically positioned vertically so as to absorb the weight load in the axial direction with the main hydraulic cylinder. A feeding system for the hydraulic cylinder allows actuating the main hydraulic cylinder in order to allow the axial extension or compression thereof. In particular, the axial extension takes place by means of the pumping of a fluid within the main hydraulic cylinder, while the axial compression takes place by means of the controlled release of part of the fluid contained within the hydraulic cylinder. The feeding system for hydraulic cylinders of known type typically comprises an alternating pump, actuated by hand by means of a lever which controls the axial extension and compression of a pumping element made in turn by a hydraulic cylinder, which for the sake of clarity is herein called hydraulic service cylinder. Such a hydraulic service cylinder receives in suction a fluid starting from a tank, typically integrated in the feeding system, and pushes such a fluid under pressure towards the hydraulic cylinder.

Moreover, such a feeding system comprises a valve, for example a tap valve, acting between the delivery opening of the auxiliary hydraulic cylinder and the main hydraulic cylinder, and is configured to allow the controlled release of the fluid from the main hydraulic cylinder. Under the effect of the weight of the load, in use, even partial opening of the valve causes a discharge of the fluid from the main hydraulic cylinder with the consequent axial compression thereof.

The applicant has found that the use of hand pumps can be inconvenient or difficult. In particular, having observed that hydraulic jacks of the type described can reach capacities even of several tens of tons, it has been observed that the operation of the lever can be tiring, above all if the main hydraulic cylinder must be extended by a significant length. The effort is compared in each case with the length of the lever, and as the length of the lever increases, the effort is typically reduced.

The lever actuation requires space, and when the hydraulic jack is installed in small environments, the actuation or full actuation of the lever can be difficult.

However, the use of a manual feeding system does not depend on power sources that use external energy resources such as electric or motor pumps; it follows a remarkable flexibility of use, even in remote environments.

It should be noted that the present prior art section is provided only to outline some technical aspects with respect to which the disclosure is so compared. The structures described above must not be considered as prior art only because of the fact that they are discussed in the present section. On the contrary, some aspects of the preceding description may for example not have been made known to the public, and therefore should not be considered as such.

The object of the present disclosure is to provide a feeding system for hydraulic jacks, which allows solving the drawbacks described above and allows first of all operating flexibility for the actuation of the main hydraulic cylinder and which also allows limiting the effort of the operator for the actuation of said main hydraulic cylinder also for handling heavy loads.

Also, it is an object of the present disclosure to provide a hydraulic jack employing said feeding system and a method of actuating said hydraulic jack which allow the aforementioned drawbacks to be solved, and which also allow, first of all, operating flexibility of actuation of the main hydraulic cylinder and also allow limiting the effort of the operator for the actuation of said main hydraulic cylinder also for handling heavy loads.

### SUMMARY

According to the present disclosure, a feeding system for a hydraulic jack is described, comprising:
a body (101; 132) configured to contain a determined amount of fluid and having an outlet (150) through which, in use, the fluid is fed to a main hydraulic cylinder (107c) of the hydraulic jack (100);
a first pumping subsystem (121; 122; 140; 142; 123) with alternating manual drive, installed on said body (101; 132) and configured to draw the fluid from said body and feed it to said outlet (150);
a second pumping subsystem (118), distinct and independent of the first pumping subsystem, installed on said body (101; 132), configured to be rotated by a tool, and configured to draw the fluid from said body and feed it to said outlet (150).

According to a further non-limiting aspect, the first pumping subsystem comprises a piston (122) and/or an alternating pump; said piston (122) and/or alternating pump being configured to be driven by an actuation lever (142), optionally rotating with respect to a predetermined pivot point (140).

According to a further non-limiting aspect, the second pumping subsystem (118) comprises a piston (120s) and/or an alternating pump, and an eccentric rotating system (112-117), constrained on said body (101; 132) so as to be able to rotate with respect to its own axis of rotation (W), said eccentric rotating system (112-117) interacting with said piston (120s) and/or alternating pump so that through its rotation the actuation of said piston (120s) and/or of said alternating pump is caused.

According to a further non-limiting aspect, said piston (120s) and/or said alternating pump comprise a rest position and a plurality of unstable positions distinct from said rest position, and wherein each position of said plurality of unstable positions is determined by the mechanical interaction between said piston (120s) and said eccentric rotating system (112-117) and/or between said alternating pump and said eccentric rotating system.

According to a further non-limiting aspect, the second pumping subsystem (118) comprises a spring (120m) adapted to push said piston (120s) into the rest position.

According to a further non-limiting aspect, the second pumping subsystem (118) comprises a thrust plate (120) installed in correspondence of a free end of said piston (120s) and/or of the alternating pump, said thrust plate (120) being in contact and/or direct mechanical interaction with said eccentric rotating system (112, 117).

According to a further non-limiting aspect, the body (101; 132) comprises a first portion (101) and a second portion (132) which can be removably coupled together in correspondence of at least one respective main coupling surface, and wherein said first portion (101) comprises a recess (110) in use at least partially filled with the fluid, said recess (110) being adapted to house at least part of the second pumping subsystem (118).

According to a further non-limiting aspect, the body (101; 132) comprises a tank for said fluid, optionally arranged in correspondence of the second portion (132) and in communication with said recess (110).

According to a further non-limiting aspect, the body (101, 132) comprises a hole (111) within which part of the eccentric rotating system (112-117) is introduced extending beyond and/or out from the body (101; 132) with an engagement element (112) adapted to be actuated in rotation by said tool or actuator.

According to a further non-limiting aspect, the eccentric rotating system (112-117) comprises a shaft (114) provided with a key (115) and a disc (116) with eccentric rotation provided with a through hole (117) inside which said shaft (114) is partially introduced with said key.

According to a further non-limiting aspect, said disc (116) acts in mechanical contrast with said piston (120s) and/or with said thrust plate (120).

According to a further non-limiting aspect, the feeding system for hydraulic jacks further comprises at least one safety valve (124) installed on said body (101; 132) having a closed position, which is a rest position at which the safety valve prevents the passage of the fluid, and an open, optionally unstable position, at which the safety valve allows the passage of the fluid; said safety valve (124) being configured to automatically switch between said closed position and said open position when the pressure of said fluid inside the body (101; 132) and/or on the outlet (150) exceeds a predetermined value.

According to a further non-limiting aspect, the feeding system for hydraulic jacks further comprises at least one service valve (125, 126), hydraulically interposed between the outlet (150) and the first pumping subsystem and the second pumping subsystem; said service valve comprising a first closed operating position, in which it prevents the passage of the fluid and at least a second at least partially open operating position in which it allows the controlled passage of the fluid.

According to a further non-limiting aspect, said first pumping subsystem (121; 122; 140; 142; 123) comprises an own delivery opening in hydraulic communication with said outlet (150) and the second pumping subsystem (118) comprises its own delivery opening in hydraulic communication with said outlet (150).

According to a further non-limiting aspect, the service valve (125, 126) is interposed between the outlet (150) and the delivery openings of the first pumping subsystem (121; 122; 140; 142; 123) and of the second pumping subsystem (118).

According to a further non-limiting aspect, the system comprises at least a first non-return valve (160) introduced between the delivery openings of the first pumping subsystem (121; 122; 140; 142; 123) and the outlet (150) or between the delivery opening of the second pumping subsystem (118) and the outlet (150), said valve being configured to allow the passage of the fluid only towards said outlet (150) and to prevent the return of the fluid towards the respective delivery opening.

According to a further non-limiting aspect, the system comprises a first non-return valve (160) introduced between the delivery opening of the first pumping subsystem (121; 122; 140; 142; 123) and the outlet (150) and a second non-return valve (160) introduced between the delivery opening of the second pumping subsystem (118) and the outlet (150), said first and said second non-return valve (160) being configured to allow the passage of the fluid only towards said outlet (150) and to prevent the return of the fluid to the respective delivery opening.

According to a further non-limiting aspect, the body (101; 132) comprises a first conduit (144b) formed between the delivery opening of the first pumping subsystem (121; 122; 140; 142; 123) and the outlet (150) and a second conduit (144a) formed between the delivery opening of the second pumping subsystem (118) and the outlet (150).

According to a further non-limiting aspect, the first non-return valve (160) is introduced into the first conduit (144b) and the second non-return valve (160) is introduced into the second conduit (144a).

According to a further non-limiting aspect, said second supply subsystem is configured to be actuated by an external actuator, optionally by a remotely controlled-type actuator.

According to a further non-limiting aspect, a hydraulic jack (100) is described, comprising a main hydraulic cylinder (107c) comprising an axially movable portion at least between a first position of smaller extension and a second position of greater extension, and a support (107) for gripping or lifting loads, connected with a portion of the main hydraulic cylinder (107c) in such a way as to be moved according to the movement of the main hydraulic cylinder (107c) itself, said hydraulic jack (100) comprising a feeding system according to one or more of the preceding aspects.

According to a further non-limiting aspect, said main hydraulic cylinder (107c) is installed in a fixed and/or rigid manner on the body of said hydraulic jack (100).

According to a further non-limiting aspect, said main hydraulic cylinder (107c) is arranged substantially vertically, and the axial movement of the axially movable portion of the main hydraulic cylinder (107c) between the first position and the second position determines a height variation of the support (107).

According to a further non-limiting aspect, said hydraulic jack (100) comprises a plurality of rotated bodies (106) adapted to facilitate the handling thereof on the ground.

According to a further non-limiting aspect, said hydraulic jack (100) comprises a lever (103) for actuating the first pumping subsystem.

According to a further non-limiting aspect, a kit is described comprising a feeding system for hydraulic jacks according to one or more of the preceding aspects, and an actuator (200, 201, 202) removably couplable or removably coupled to said second pumping subsystem and configured to at least temporarily activate or deactivate said second pumping subsystem, wherein the actuator (200, 201, 202) is a remotely controlled-type actuator.

According to a further non-limiting aspect, said actuator (200, 201, 202) comprises an electric motor and/or a motor rotatably actuated by hydraulic means.

According to a further non-limiting aspect, said actuator comprises a remote control system.

According to a further non-limiting aspect, a method of actuating a hydraulic jack (100) is described, said method comprising an actuation step of a main hydraulic cylinder (107c) for moving a load by means of a feeding system according to one or more of the preceding aspects.

In particular, according to a further non-limiting aspect, a method of actuating said hydraulic jack (100) is described, comprising:
an actuation step of a main hydraulic cylinder (107c) for moving a load by at least the feeding of fluid respectively towards said main hydraulic cylinder (107c) by means of a feeding system for a hydraulic jack, comprising a body (101; 132) configured to contain a determined amount of fluid and having an outlet (150) through which, in use, the fluid is fed to the main hydraulic cylinder (107c) of the hydraulic jack (100);
   said actuation method comprising alternatively or in combination:
the alternating manual actuation of a first pumping subsystem (121; 122; 140; 142; 123) of said feeding system, wherein the first pumping subsystem (121; 122; 140; 142; 123) is configured to draw the fluid from said body and feed it to said outlet (150); or
the rotation of a second pumping subsystem (118) of said feeding system, said second pumping subsystem being distinct and independent of the first pumping subsystem, and configured to draw the fluid from said body and feed it to said outlet (150).

According to a further non-limiting aspect, the method comprises an alternating manual actuation step of a piston (122) and/or an alternating pump of the first pumping subsystem, in particular the alternating manual operation of an actuating lever (142) rotating with respect to a predetermined pivot point (140).

According to a further non-limiting aspect, the actuation in rotation of the second pumping subsystem (118) comprises the actuation of a piston (120s) and/or an alternating pump of said second pumping subsystem (118) by rotating an eccentric rotating system (112-117), constrained on said body (101; 132) so as to be able to rotate with respect to a rotation axis (W), said eccentric rotating system (112-117) interacting with said piston (120s) and/or an alternating pump so that the actuation of said piston (120s) and/or of said alternating pump is determined through its rotation.

According to a further non-limiting aspect, the actuation in rotation of the second pumping subsystem (118) causes a movement of said piston (120s) and/or of said alternating pump between a rest position and a plurality of unstable positions distinct from said rest position, and wherein each position of said plurality of unstable positions is determined by the mechanical interaction between said piston (120s) and said eccentric rotating system (112-117) and/or between said alternating pump and said eccentric rotating system.

According to a further non-limiting aspect, the actuation in rotation of the second pumping subsystem (118) causes the cyclic compression of a spring (120m) thereof adapted to push said piston (120s) into the rest position.

According to a further non-limiting aspect, the actuation of the system causes a fluid transfer between a fluid tank formed on the body (101; 132), optionally formed in correspondence of the second portion (132), and in communication with said recess (110) and the main hydraulic cylinder (107c).

According to a further non-limiting aspect, the actuation of the second pumping subsystem comprises the engagement of a tool or actuator with an engagement element (112) of the second pumping subsystem, said engagement element (112) extending outside of a hole (111) made on the body (101, 132) and inside which part of the eccentric rotating system (112-117) is introduced extending beyond and/or out of the body (101; 132) with said engagement element (112).

According to a further non-limiting aspect, the method comprises an actuation step of a service valve (12, 126) for discharging the fluid under pressure from the main hydraulic cylinder (107c), the service valve (125, 126) is hydraulically interposed between the outlet (150) and the first pumping subsystem and the second pumping subsystem; said actuation of the service valve comprising the movement thereof between a first closed operating position, in which it prevents the passage of the fluid and at least a second at least partially open operating position in which it allows the controlled passage of the fluid.

According to a further non-limiting aspect, the actuation of the first pumping subsystem, or of the second pumping subsystem, causes the flow of the fluid through at least a first non-return valve (160) introduced between the delivery opening of the first pumping subsystem (121; 122; 140; 142; 123) and the outlet (150) or between the delivery opening of the second pumping subsystem (118) and the outlet (150), said valve being configured to allow the passage of the fluid only towards said outlet (150) and to prevent the return of the fluid towards the respective delivery opening.

### DESCRIPTION OF THE FIGURES

The hydraulic jack will be described in a preferred non-limiting embodiment thereof with reference to the accompanying figures, in which:

FIG. 1 shows a perspective view of a hydraulic jack according to the present disclosure;

FIG. 2 shows a perspective view of a feeding system for the hydraulic jack of the disclosure;

FIG. 3 shows a front view of a first alternative embodiment of part of the feeding system for the hydraulic jack;

FIG. 4 shows a front view of a second alternative embodiment of part of the feeding system for said hydraulic jack; and

FIG. 5 shows a hydraulic diagram of the feeding system.

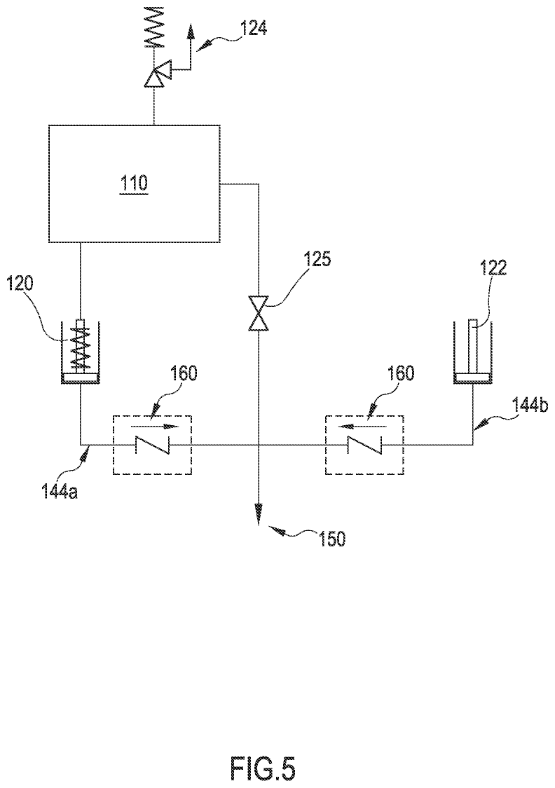

### DETAILED DESCRIPTION

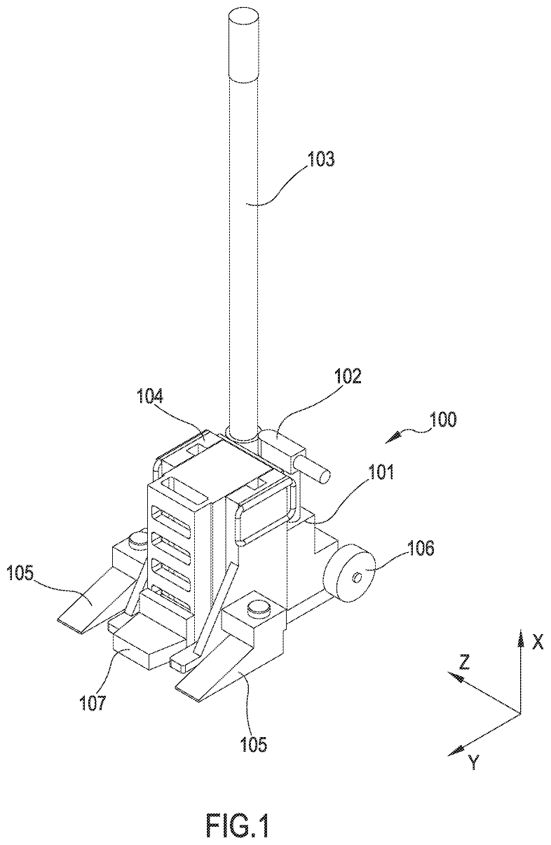

With reference to the accompanying figures, and in particular with reference to FIG. 1, reference numeral 100 indicates a hydraulic jack as a whole, adapted to lift loads preferably in a vertical axial direction.

For greater comprehensibility of the description, the present description is provided with reference to a first reference axis X, or vertical axis, with reference to a second reference axis Y, orthogonal with respect to the first reference axis X, and with reference to a third reference axis Z, orthogonal with respect to the second reference axis Y and the first reference axis X.

The hydraulic jack 100 comprises a body preferably rotated, provided with a plurality of wheels 106 which are installed in a rear area of the jack and which are configured to facilitate the movement thereof on the ground. On the body 101 the hydraulic jack has a main hydraulic cylinder 107c installed, arranged so as to have its axis substantially parallel to the first reference axis X; the main hydraulic cylinder 107c is configured to move between a first, preferably minimum, axial extension and a second, preferably maximum, axial extension, so as to allow raising or lowering of a load. The hydraulic cylinder 107c has a movable part and a fixed part, and the latter is rigidly fixed to the body 101. A support 107 is constrained to the movable portion on which the load is rested in use. A fork 105 extends on the left and right side of the body 101, and in use rests on the ground to achieve a solid support for the weight of the load when raised.

A movement lever 103 is preferably rigidly but removably fixed on the body 101 in order to allow an easy movement of the hydraulic jack 100, in particular when implemented in its higher capacity versions, which are characterized by a significant weight.

The hydraulic jack 100 comprises a particular feeding system for the main hydraulic cylinder 107c, which is configured to allow the supply of a pressurized fluid to the hydraulic cylinder itself and to allow the pressure or the fluid to be released gradually or in any case in a controlled manner from said hydraulic cylinder, so that under the pressure of the fluid the main hydraulic cylinder 107c can be axially extended or, due to the controlled release of the pressure or of the fluid, the main hydraulic cylinder 107c can be axially compressed in order to lower the load.

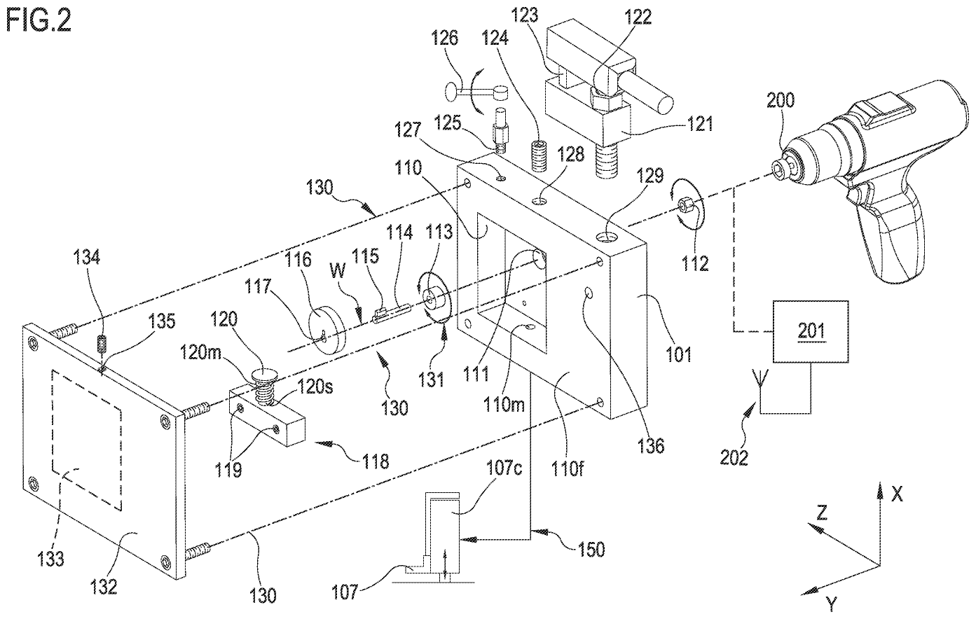

As shown in FIG. 2, the feeding system comprises a body formed by a first portion 101 and a second portion 132, which is configured to contain a certain quantity of fluid and which has an outlet 150 through which in use the fluid is fed to a main hydraulic cylinder 107c of the hydraulic jack itself.

On the body, a first pumping subsystem 121, 122, 123, 140, 142 and a second pumping subsystem 118 are identified, both intended to allow the feeding of the pressurized fluid to the main hydraulic cylinder 107c by means of the outlet 150. In particular, the first pumping subsystem is of the alternating manual actuation type, which occurs in particular by means of a manually operated lever, while the second pumping subsystem 118 is of the rotating actuation type and is in particular configured to be actuated by an external tool or actuator such as a drill, an electric motor, a rotary pump or other.

The first portion of the body 101 comprises a recess 110 adapted to house at least part of the second pumping subsystem 118 and, moreover, a determined quantity of fluid preferably not under pressure. The recess 110 opens on a front wall 110f of the first body portion, which is opposite to a second rear wall at which there is a through hole 111, opening in the recess 110 and in particular on a bottom wall thereof. The hole 111 allows the passage of part of the second pumping subsystem outside the structure of the body 101, 132 so that it is possible to actuate it by means of said external tool or actuator.

The front wall 110f, of the planar type, is coupled with the corresponding wall of the second portion 132, through a plurality of screws adapted to enter into respective threaded recesses which open onto the front wall 110f itself and which have axes 130 parallel to the second reference axis Y. The fluid seal between the first and the second portion is provided, for example and not limited to, by a gasket, not shown in the accompanying figures.

A delivery opening also opens in the recess 110; such a delivery opening is configured to allow the feeding of pressurized fluid towards the outlet 150.

Within the hole 111 a friction reduction element 113 is introduced, such as for example and not limited to a ball bearing, with function of stopping the passage of fluid, on which a shaft 114 is installed, in particular by contrast insertion, which extends axially along a direction parallel to the direction identified by the second reference axis Y. The shaft 114 preferably extends out of the first body portion 101 and is fixed in correspondence of a first end thereof on an engagement element 112 such as for example and not limited to an octagonal nut, designed to be rotated by the external tool or actuator.

In correspondence of the end opposite to the end fixed to the engagement element 112, the shaft 114 has a key 115 engaged with a disc-shaped element 116 with an eccentric rotation, which has a hole 117 for said shaft and said key.

The assembly formed by the shaft 114, the key 115, the disc-shaped element 116 and, preferably, also the friction reduction element 113 and the engagement element 112 implements an eccentric rotating system for the actuation of an alternating pump or a piston 120s forming part of the second pumping subsystem 118. The rotation with respect to an axis parallel to the second reference axis Y is shown in FIG. 2 by the two-way arrow 131, and such an axis is shown in the figure as axis W.

The second pumping subsystem 118 in fact comprises a base which can be removably fixed in correspondence of the bottom wall of the recess 110 by means of a pair of screws 119, which comprises a piston 120s at least partially enclosed by a helical spring 120m. The piston extends along a direction substantially parallel to the direction identified by the first reference axis X. Such a spring 120m has a first end resting on a side wall of said base and a second end opposite to the first end fixed on a plate 120 in turn constrained on the end of the said piston 120s. The spring 120m is configured so as to allow the piston 120s to be maintained in a rest position, preferably corresponding to a position of maximum axial extension. The axial compression of the piston 120s causes an axial compression of the spring 120m; consequently, the positions different from the rest position are unstable positions for the piston 120s, which tends to be brought back to the rest position by the spring.

At each cycle of axial compression of the piston, the fluid is pushed towards the delivery opening and hence towards the outlet 150. The axial extension of the piston does not cause fluid suction from the outlet 150. Preferably, therefore, it is a pressing type pump.

In particular, the rotation of the eccentric rotating system around the axis W causes a cyclic axial compression of the piston which causes the pumping of the fluid towards the outlet 150.

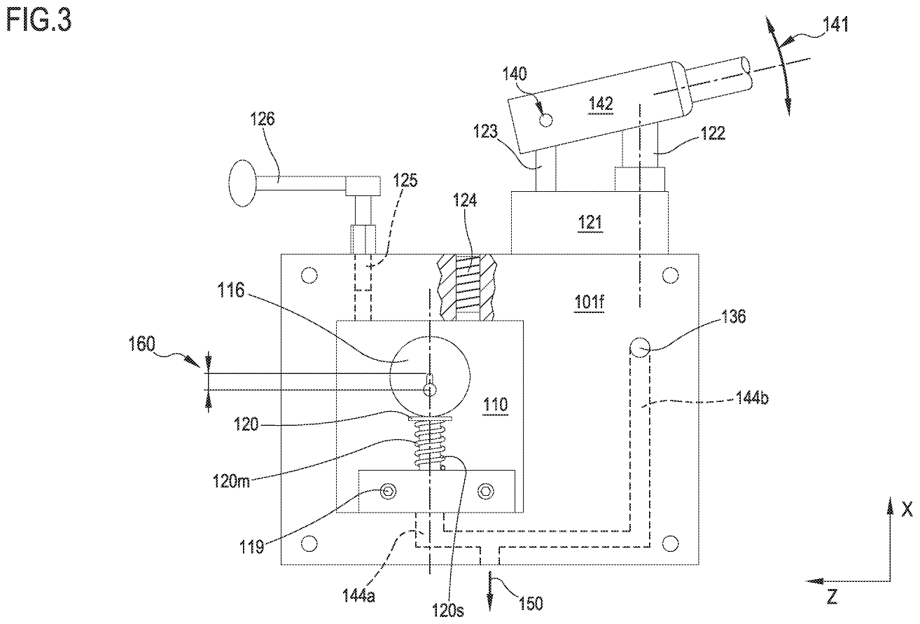

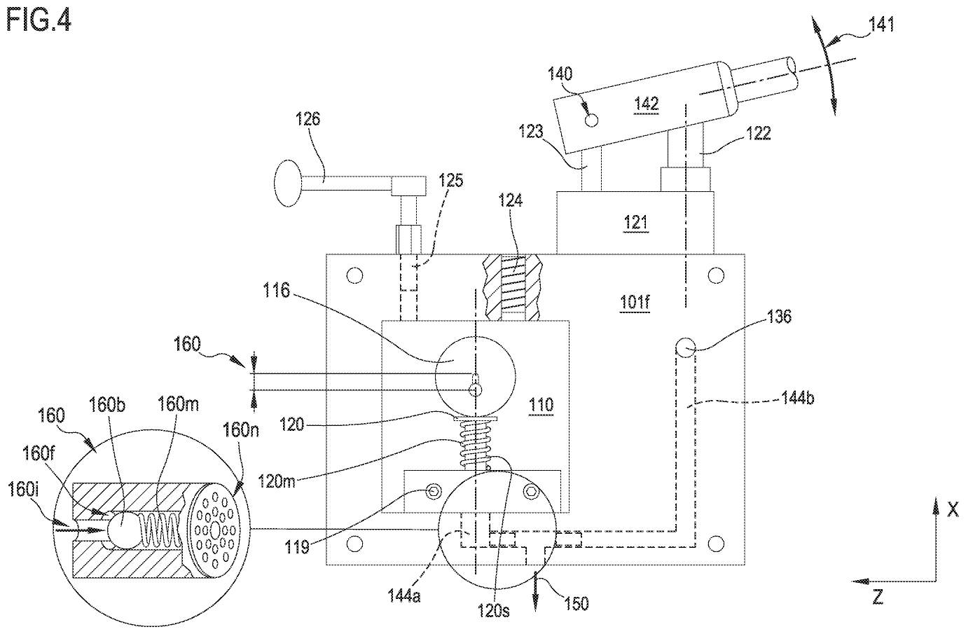

The first pumping subsystem 121, 122, 123, 140, 142, the first pumping subsystem comprises a piston 122 and/or an alternating pump, preferably but not limited to a pressing type; said piston 122 and/or alternating pump are adapted to be actuated by an actuating lever 142 rotating with respect to a predetermined pivot point 140. In particular, the first pumping subsystem comprises a base 121 screwed onto the first portion of the body 101 in correspondence of a threaded hole 129 inside which part of the piston 112 or of the alternating pump is housed. From the upper portion of the base 121 there extends a support 123 which ends on a pin 140 at which one end of the actuating lever 142 is rotatably fixed which is in turn constrained to the piston 122, so that a rotation of the actuating lever 142 with respect to the pivot point (rotation which is identified by the double-pointed arrow 141, in FIG. 3 and in FIG. 4), causes the introduction or removal of the piston 122 from the base 121 and from the first portion 101 of the body to push the fluid towards the outlet 150.

The withdrawal of fluid in aspiration can take place from the recess 110 or from a hole 136 positioned in correspondence of the front wall 110f.

In correspondence of the upper wall of the first portion 101 of the body there is also a safety valve 124, installed in use within a service hole 128 which puts the recess 110 into communication with the safety valve itself; such a valve is configured to allow venting to the outside excessive pressures which can occur within the recess 110 when a predetermined pressure threshold is exceeded; the safety valve 124 operates with a spring control, which, after having exceeded the predetermined pressure threshold, which may be adjusted with appropriate spring preloading, opens the valve and closes it only when said pressure has fallen below the predetermined threshold.

The feeding system described herein also comprises a service valve 125, 126 which in the embodiment shown in the accompanying figures is represented as a tap provided with a control handle 126 and a threaded body 125 adapted to enter a respective threaded hole 127. The service valve is configured to allow the fluid pressure from the main hydraulic cylinder 107c to be released in a controlled manner, in particular according to the degree of rotation of the handle 126. Preferably, but not limited to, the service valve 125, 126 is interposed between the delivery openings of the first and second pumping subsystem and the outlet 150, or in any case downstream of the first and second pumping subsystem.

Through the opening of the service valve 125, 126, the pressurized fluid passes from the main hydraulic cylinder 107c directly to the tank and/or recess 110.

FIG. 2 also illustrates two types of actuators for actuating the second pumping subsystem. A first type of actuator consists, for example and not limited to, of a drill 200 which has a mandrel provided with an engagement element adapted to couple with the engagement element 112. A second type of actuator consists for example of an electric motor 201 which is electronically controlled remotely, for example by means of a radio signal which is received through an antenna 202.

The second portion 132 of the body preferably but not limited to takes up the shape of the first portion 101, and is provided with a tank 133 which in FIG. 2 is indicated with reference numeral 133. The second portion 132 of the body also has a removable cap 134, for example of the threaded type, adapted to enter into a filling hole 135. Such a hole is in direct communication with the tank 133, and advantageously allows the oil contained in the tank 133 to be refilled without the need to subdivide the first portion from the second portion.

As can be seen by observing FIG. 3, between the delivery opening of the first pumping subsystem and the outlet 150 there is a first conduit 144b, and between the delivery opening of the second pumping system and the outlet 150 there is a second conduit 144a; these first and second conduits join in correspondence of the outlet 150, where there is a hole through which the fluid can be transferred towards the main hydraulic cylinder 107c.

However, in a further alternative and non-limiting embodiment, illustrated in FIG. 4, in the first conduit and in the second conduit there are a first and a second non-return valve 160, respectively, which are configured to allow the passage of fluid only in one direction; with the particular configuration with which they are installed, these first and second non-return valves 160 are configured to allow the passage of the fluid only in the direction starting from the delivery opening of the respective pumping subsystem towards the outlet 150. Preferably, although not limited to, the first and second non-return valves integrate a ball held in a rest position against a bottom wall 160f by a spring 160m, which under the effect of the fluid pressure on the inlet 160i is compressed, thus freeing the passage of the fluid towards the outlet 160u of the non-return valve itself. A fluid back pressure on the outlet 160u causes a reinforcement of the thrust of the ball 160f already exerted by the spring 160m against the bottom wall 160f, and this causes the prevention of the passage of the fluid in the opposite direction. Although FIG. 4 shows two non-return valves, this configuration is not to be considered as limiting, since the non-return valve could also be only one. The use of non-return valves optimizes the independence of operation of the two pumping subsystems, since the actuation of one of the two causes the fluid to be unable to act on the other pumping subsystem. In fact, the first non-return valve 160 is installed on the first conduit 144b, and the second non-return valve 160 is installed on the second conduit 144a.

The advantages of the feeding system, and consequently, of the hydraulic jack described thus far are apparent in the light of the foregoing description. The hydraulic jack is of flexible use since it can be used either through the traditional lever, or through a tool or actuator which allows a faster and easier movement of the main hydraulic cylinder when it comes to moving heavy weight loads or, alternatively, one must work in narrow areas where the traditional lever cannot be used. Also, with a remote control of the actuator acting on the second pumping subsystem, it is possible to remotely control the operation of the hydraulic jack. This allows, for example and not limited to, moving the operator away from the traditional position near the load, placing the operator in a safer position or working condition, for example less subject to crushing risk should the load inadvertently fall from the support 107.

The Applicant advantageously notes that the first and the second pumping subsystem can be activated in an alternative selective activation process or even in combination; the advantageous effects offered by the first and second pumping subsystem are combined synergistically. In particular, the simultaneous actuation of the first and second pumping subsystem may not cause disturbances and/or negative interactions on the other pumping subsystem.

It is finally apparent that additions, modifications or variations, obvious to a person skilled in the art may apply to the object of the disclosure, without thereby departing from the scope of protection provided by the accompanying claims.

1. A feeding system for a hydraulic jack, comprising:
a body configured to contain a determined amount of fluid and having an outlet through which, in use, the fluid is fed to a main hydraulic cylinder of the hydraulic jack;
a first pumping subsystem with alternating manual drive, installed on said body and configured to draw the fluid from said body and feed it to said outlet;
a second pumping subsystem, distinct and independent of the first pumping subsystem, installed on said body, configured to be rotated by a tool, and configured to draw the fluid from said body and feed it to said outlet.

2. The system according to claim 1, wherein the first pumping subsystem comprises a piston and/or an alternating pump; said piston and/or alternating pump being configured to be driven by an actuation lever, optionally rotating with respect to a predetermined pivot point.

3. The system according to claim 1, wherein the second pumping subsystem comprises a piston and/or an alternating pump, and an eccentric rotating system, constrained on said body so as to be able to rotate with respect to its own axis of rotation, said eccentric rotating system interacting with said piston and/or alternating pump so that through its rotation the actuation of said piston and/or of said alternating pump is caused,
and wherein said piston and/or said alternating pump comprise a rest position and a plurality of unstable positions distinct from said rest position, and wherein each position of said plurality of unstable positions is determined by the mechanical interaction between said piston and said eccentric rotating system and/or between said alternating pump and said eccentric rotating system.

4. The system according to claim 3, wherein the second pumping subsystem comprises:
a spring adapted to push said piston into the rest position; and
further comprises a thrust plate installed in correspondence of a free end of said piston and/or of the alternating pump, said thrust plate being in contact and/or direct mechanical interaction with said eccentric rotating system.

5. The system according to claim 1, wherein the body comprises a first portion and a second portion which can be removably coupled together in correspondence of at least one respective main coupling surface, and wherein said first portion comprises a recess in use at least partially filled with the fluid, said recess being adapted to house at least part of the second pumping subsystem;
said body comprising a tank for said fluid, optionally arranged in correspondence of the second portion and in communication with said recess.

6. The system according to claim 3, wherein the body comprises a hole within which part of the eccentric rotating system is introduced extending beyond and/or out from the body with an engagement element adapted to be actuated in rotation by said tool or actuator;
and wherein the eccentric rotating system comprises a shaft provided with a key and a disc with eccentric rotation provided with a through hole inside which said shaft is partially introduced with said key.

7. The system according to claim 1, further comprising:
at least one safety valve installed on said body having a closed position, which is a rest position at which the safety valve prevents the passage of the fluid, and an open, optionally unstable, position at which the safety valve allows the passage of the fluid; said safety valve being configured to automatically switch between said closed position and said open position when the pressure of said fluid inside the body and/or on the outlet exceeds a predetermined value;
at least one service valve, hydraulically interposed between the outlet and the first pumping subsystem and the second pumping subsystem; said service valve comprising a first closed operating position, in which it prevents the passage of the fluid and at least a second at least partially open operating position in which it allows the controlled passage of the fluid.

8. The system according to claim 1, wherein said first pumping subsystem comprises an own delivery opening in hydraulic communication with said outlet and the second pumping subsystem comprises its own delivery opening in hydraulic communication with said outlet;
said system comprising at least a first non-return valve introduced between the delivery opening of the first pumping subsystem and the outlet or between the delivery opening of the second pumping subsystem and the outlet, said valve being configured to allow the passage of the fluid only towards said outlet and to prevent the return of the fluid towards the respective delivery opening.

9. The system according to claim 8, comprising a first non-return valve introduced between the delivery opening of the first pumping subsystem and the outlet and a second non-return valve introduced between the delivery opening of the second pumping subsystem and the outlet, said first and said second non-return valve being configured to allow the passage of the fluid only towards said outlet and to prevent the return of the fluid to the respective delivery opening;
wherein the body comprises a first conduit formed between the delivery opening of the first pumping subsystem and the outlet and a second conduit formed between the delivery opening of the second pumping subsystem and the outlet;
and wherein the first non-return valve is introduced into the first conduit and the second non-return valve is introduced into the second conduit.

10. A hydraulic jack, comprising a main hydraulic cylinder comprising an axially movable portion at least between a first position of smaller extension and a second position of greater extension, and a support for gripping or lifting loads, connected with a portion of the main hydraulic cylinder in such a way as to be moved according to the movement of the main hydraulic cylinder itself, said hydraulic jack comprising a feeding system according to claim 1.

11. The hydraulic jack according to claim 10, wherein said main hydraulic cylinder is installed in a fixed and/or rigid manner on the body of said hydraulic jack and is arranged substantially vertically, and the axial movement of the axially movable portion of the main hydraulic cylinder between the first position and the second position determines a height variation of the support;
said hydraulic jack comprising a lever for actuating the first pumping subsystem.

12. (canceled)

13. A method for actuating an hydraulic jack, comprising:
an actuation step of a main hydraulic cylinder for moving a load by at least the feeding of fluid respectively towards said main hydraulic cylinder by means of a feeding system fora hydraulic jack, comprising a body configured to contain a determined amount of fluid and having an outlet through which, in use, the fluid is fed to the main hydraulic cylinder of the hydraulic jack;
said actuation method comprising:
the alternating manual actuation of a first pumping subsystem of said feeding system, wherein the first pumping subsystem is configured to draw the fluid from said body and feed it to said outlet; or
the rotation of a second pumping subsystem of said feeding system, said second pumping subsystem being distinct and independent of the first pumping subsystem, and configured to draw the fluid from said body and feed it to said outlet.

14. The method according to claim 13, further comprising an alternating manual actuation step of a piston and/or an alternating pump of the first pumping subsystem, in particular the alternating manual operation of an actuating lever rotating with respect to a predetermined pivot point;
and/or comprising the actuation in rotation of the second pumping subsystem comprises the actuation of a piston and/or an alternating pump of said second pumping subsystem by rotating an eccentric rotating system, constrained on said body so as to be able to rotate with respect to a rotation axis, said eccentric rotating system interacting with said piston and/or an alternating pump so that the actuation of said piston and/or of said alternating pump is determined through its rotation,
and wherein the actuation in rotation of the second pumping subsystem causes a movement of said piston and/or of said alternating pump between a rest position and a plurality of unstable positions distinct from said rest position, and wherein each position of said plurality of unstable positions is determined by the mechanical interaction between said piston and said eccentric rotating system and/or between said alternating pump and said eccentric rotating system.
